(19) United States
(12) Patent Application Publication
(10) Pub. No.: US 2003/0127239 A1
(43) Pub. Date: Jul. 10, 2003

(54) Process for manufacturing a cylindrical body and a cable incorporating a body obtained by this process

(76) Inventor: Lionel Fomperie, Auffargis (FR)

Correspondence Address: SOFER & HAROUN, L.L.P., Suite 910, 317 Madison Avenue, New York, NY, 10017, US

(21) Appl. No.: 10/234,644

(22) Filed: Sep. 3, 2002

(30) Foreign Application Priority Data
Sep. 3, 2001 (FR) 01 11505

(51) Int. Cl. H01B 7/00; B29C 47/78

(52) U.S. Cl. 174/24; 264/211.24

(57) ABSTRACT

A process for manufacturing a cylindrical body comprises a step of blending at least two unsaturated polymer chains each having at least one branch with a carbon-carbon double bond and a hydrosilylizing compound having at least two silicon-hydrogen bonds in the presence of at least one hydrosilylation catalyst, the blend obtained being uncrosslinked, and a step of extruding the blend. The crosslinking of the blend by hydrosilylation is completed after the extrusion step. The process is intended in particular to be employed in the cablemaking field.

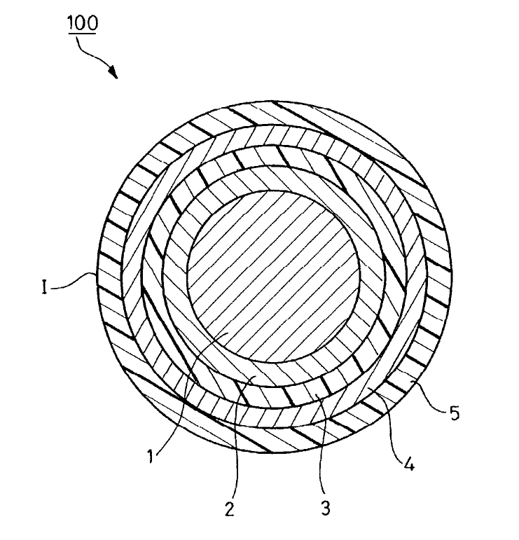

### BACKGROUND OF THE INVENTION

1. Field of the Invention

The present invention relates to a process for manufacturing a cylindrical body intended in particular to be used in cable accessories or as a sheath and/or insulation for telecommunication or power cables.

For this type of use, the aim is to manufacture cylindrical bodies having good thermomechanical properties.

2. Description of the Prior Art

The prior art cylindrical bodies that satisfy this criterion best are compositions based on crosslinked polymers in which a three-dimensional structure is formed by covalent bonds between the chains.

Compositions based on crosslinked polymers are obtained with the aid of silanes such as vinylsilane, which is often grafted onto the polymers. This kind of crosslinking process in particular implies, after extrusion, immersing the composition in hot water (referred to as immersion in a swimming pool). Consequently, immersion in water being particularly costly and necessitating dedicated infrastructures, the manufacture time for cables containing this kind of composition is long and not particularly compatible with industrial requirements, in particular in terms of cost-effectiveness.

Other compositions based on crosslinked polymers are obtained by a peroxide route. This necessitates, after extrusion, decomposition of the peroxide under a gas pressure and at a high temperature in long tubes, called vulcanizing tubes. This decomposition conditions the crosslinking. Also, the gas pressure can degrade some properties of the polymers (deformation of the insulation, etc). Consequently, the peroxide route leads to compositions that are somewhat costly and of limited use.

Moreover, the peroxide is introduced either during “compounding”, i.e. during the preparation of the composition in an internal or continuous mixer, or at the beginning of the subsequent extrusion step. The extrusion temperature is lower than the decomposition temperature to prevent decomposition of the peroxide during extrusion leading to precrosslinking of the composition, degrading its final properties. The composition is therefore somewhat viscous, as a result of which the extrusion speed is somewhat low.

Accordingly, prior art processes for manufacturing compositions based on crosslinked polymer comprise a series of complex and costly steps.

Prior art polymer compositions have also been produced by a reaction known as hydrosilylation.

The patent application WO-9833801 discloses a process for hydrosilylation of an unsaturated polymer composition, i.e. a composition comprising at least one carbon-carbon double bond, using a hydrosilylation compound comprising at least one silicon hydride type silicon-hydrogen bond, using a catalyst platinum-based and a reaction promoter. In this hydrosilylation reaction, the carbon-carbon double bond reacts with the silicon-hydrogen bond. The examples described principally feature grafting of hydrosilylation compounds at terminal groups of the unsaturated polymer composition. The above document also specifies that if a sufficient number of carbon-carbon double bonds and silicon-hydrogen bonds are available and react, the polymer composition can form a three-dimensional network by hydrosilylation, and thereby be crosslinked.

The objective of the above document is to increase the reactivity of the catalyst by using the reaction promoter to accelerate the hydrosilylation reaction. The description of the process mentions that hydrosilylation is carried out with the constituents in constant motion, and preferably in a solvent medium, the unsaturated compound and the silicon hydride then being in solution. In this latter case, a subsequent step of evaporating the solvent and the other reagents recovers the hydrosilylized and possibly crosslinked polymer composition.

When the above kind of hydrosilylation process yields a crosslinked polymer composition, the crosslinking prevents any subsequent forming step because it occurs during blending of the constituents. Consequently, the above prior art hydrosilylation process cannot be used to manufacture a sheath and/or insulation for cables.

An object of the present invention is to develop a process for manufacturing a cylindrical body from a crosslinked polymer material that makes it possible to obtain a cylindrical body having good thermomechanical properties and which can be used as a sheath and/or insulation in the cable field. Also, this process must be simple, fast, in particular in the extrusion step, and of low cost.

### SUMMARY OF THE INVENTION

To this end, the present invention proposes a process for manufacturing a cylindrical body, the process comprising:

a step of blending at least two unsaturated polymer chains each having at least one branch with a carbon-carbon double bond and a hydrosilylizing compound having at least two silicon-hydrogen bonds in the presence of at least one hydrosilylation catalyst, the blend obtained being uncrosslinked, and

a step of extruding the blend,

the crosslinking of the blend by hydrosilylation being completed after the extrusion step.

In this manner, the process according to the invention can be used to manufacture a cylindrical body such as a rod or a tube intended to cover the core of power or telecommunication cables, for example. The process can also be used to produce cable sheaths. Apart from catalyst residues, the process according to the invention has the further advantage of not generating residues liable to cause breakdowns, as a result of which it is also possible to manufacture insulation for power cables.

Unlike the prior art, the hydrosilylation reaction rate is not sufficiently high—it may even be zero—during the blending of the constituents, with the result that the blend obtained is not yet crosslinked.

Furthermore, blending can be done directly in the extruder. The uncrosslinked blend has a low viscosity, which increases the extrusion speed. The viscosity behavior can in particular be controlled as a function of the hydrosilylation catalyst content. It is also possible to combine several hydrosilylation catalysts.

The uncrosslinked blend is transported by means of a screw from the feed zone of the extruder to the die. The pressure and the temperature increase progressively along the screw, thus forcing the uncrosslinked blend to change from the solid state to the melt state in the case of a crystalline polymer, or to a low-viscosity state in the case of an elastomer. The die, which is situated at the exit from a barrel, shapes the extruded blend into a cylinder.

The catalyst can be introduced in dissolved form in order to facilitate its dispersion. An evaporator placed downstream of the exit from the extruder can eliminate the solvents.

Unlike crosslinking by the silane or peroxide route, crosslinking of the blend according to the invention occurs during storage of the extruded blend in the open air and at room temperature. Crosslinking typically takes a few days to a few weeks, depending on the constituents chosen. The hydrosilylizing compound has at least two silicon-hydrogen bonds, and this difunctionality enables crosslinking to be effected by reaction with at least two polymer chains according to the invention.

Subsequent passage through an oven can accelerate crosslinking. A cylindrical body in accordance with the invention is obtained in this way.

The molecular weight of the unsaturated polymer chains used in the process according to the invention can vary as a function of the required properties. The chains can belong to the same polymer—homopolymer and copolymer—or separate polymers. The relative quantity of carbon-carbon double bonds and silicon-hydrogen bonds available is chosen to obtain the required crosslinking rate. It is desirable for the cylindrical body according to the invention to withstand the hot set test (HST) defined in French standard NF EN 60811-2-1.

To prevent crosslinking starting during blending, the duration of the blending step and the time spent in the extruder can be reduced, for example.

Accordingly, in one embodiment of the invention, the blending step has a duration significantly less than five minutes.

Another way to obtain an uncrosslinked blend is to choose a quantity of catalyst such that the hydrosilylation reaction time is longer than the blending time.

Also, the uncrosslinked blend can advantageously contain significantly less than 1% of the total weight of the catalyst(s), and preferably from 100 ppm to 300 ppm thereof.

In one embodiment of the invention, the catalyst(s) according to the invention can be chosen from molecules based on transition metals from column VIII of the Periodic Table of the Elements, such as palladium, rhodium, platinum and associated complexes.

Blending temperatures from 60° C. to 180° C. are chosen.

The duration of the blending step is preferably reduced as the chosen temperature is increased. This is because a high temperature tends to accelerate the hydrosilylation reaction.

In a preferred embodiment of the invention at least one of the carbon-carbon double bonds is of the pendent type.

In this case, the branch incorporating it is not within the main polymer chain: it can therefore be at the end of the chain or attached as a side chain. This produces higher reactivity in some cases.

According to the invention, each of the polymer chains can belong to a polymer chosen from the thermoplastic polymers.

For example, for manufacturing a cylindrical body from a thermoplastic polymer, it is possible to choose amorphous polymers or crystalline polymers having good thermomechanical properties.

Each of the polymer chains according to the invention preferably belongs to a polyvinyl chloride (PVC) known for its fire retardant properties.

In one embodiment of the invention, each of the polymer chains belongs to a polymer chosen from olefins, polyolefins and preferably from EPDMs and polyethylenes.

Polyolefins are advantageous because these plastics are widely used, and therefore obtainable at low cost, and have mechanical and electrical properties compatible with the specifications required in the cablemaking field. An EPDM is an ethylene-propylene-diene terpolymer with a methylene main chain known for its elastomeric properties. Polyethylene (PE) can be used to manufacture cables having good thermomechanical properties.

Furthermore, the hydrosilylizing compound according to the invention can be chosen from silanes, polysilanes and siloxanes.

The hydrosilylizing compound according to the invention can in particular be part of a molecule of low molecular weight or part of an oligomer.

The hydrosilylizing compound is preferably a methylhydrocyclosiloxane.

In one embodiment of the invention, the hydrosilylizing compound includes at least two silicon-hydrogen bonds carried by the same silicon.

In a variant of the invention, a fire retardant filler is added during the blending step.

Adding a filler does not prevent the hydrosilylation reaction according to the invention from taking place and can contribute to reducing costs.

The process according to the invention can produce diverse end products with the benefit of the mechanical and heat resistance properties of the crosslinked blend obtained. Examples of such end products include low-voltage, medium-voltage and high-voltage power cables and telecommunication cables whose insulation and/or sheath can be formed by a cylindrical body made from a crosslinked material obtained by the process according to the invention.

The invention will be better understood from the following examples of processs according to the invention, which are given by way of illustrative and non-limiting example.

The single FIG. shows a section through a power cable including a sheath obtained by the process according to the invention.

### EXAMPLE 1

The process in accordance with the invention of manufacturing a cylindrical body comprises:

a step of blending unsaturated polymer chains of a Vistalon 6505 type EPDM containing 9% diene of the norbornene ethylidene type having a plurality of branches with carbon-carbon double bonds of vinyl type and a hydrosilylizing compound having a plurality of sodium-hydrogen bonds such as methylhydrocyclosiloxane [(CH₃)HSiO]ₙ with n varying from 4 to 6. This is effected in the presence of a hydrosilylation catalyst, such as a 1,1,1,3,3-tetramethyl-1,3-divinylsiloxane platinum complex representing less than 1% of the total weight, and of a filler such as calcium carbonate, and

a step of extruding the blend.

The blending step is carried out at 120° C. during “compounding” in an internal or continuous mixer and has a duration of less than 5 minutes: hydrosilylation is not started, or hardly started, so that the blend is not yet crosslinked. The blend has a low viscosity up to 160° C. with the result that the extrusion step following the blending step is very fast and easy. For example, the choice is made to extrude at a temperature of 120° C. with a shear rate of the order of 15 rpm.

Crosslinking of the blend by hydrosilylation is completed after the extrusion step: after extrusion, crosslinking is allowed to proceed in the open air and at room temperature for approximately two weeks by storing the cylindrically shaped blend without special precautions to obtain the cylindrical body according to the invention.

The tensile strength (R, in MPa), the elongation at break (A, in %), the resistance (or non-resistance) to creep or deformation (according to French standard NF EN 60811-2-1 (HST)), and the Shore A hardness (according to French standard NF 51-109) of the cylindrical body are then measured. The measurement results are set out in Table 1 below.

TABLE 1

| PROPERTY | |
|---|---|
| R (MPa) | 3.6 |
| A (%) | 400 |
| HST (200° C./0.2 MPa/15 min) | yes |
| Shore A hardness | 44 |

Note that the thermomechanical properties and the resistance to creep or deformation are good. The Shore A hardness is low, which is advantageous, especially in the case of use as a sheath or insulation for cables.

### EXAMPLE 2

By replacing the EPDM of Example 1 with a Nordel 4820 and/or 4920 type PE, it is possible, in an analogous manner to Example 1, to obtain a cylindrical body according to the invention having good thermomechanical properties. The measurement results are set out in Table 2 below.

TABLE 2

| PROPERTY | |
|---|---|
| R (MPa) | 20 |
| A (%) | 450 |
| HST (200° C./0.2 MPa/15 min) | Yes |

### EXAMPLE 3

By replacing the EPDM of Example 1 with a PVC, it is possible to obtain, in an analogous manner to Example 1, a cylindrical body according to the invention able to withstand the hot set test.

### EXAMPLE 4

A power cable 100 is manufactured having a sheath obtained by the process according to the invention. The single FIG. shows a section through this power cable.

The power cable 100 has a conductive core 1 coaxially surrounded by an insulating structure I. The structure I comprises at least one semiconducting first layer 2 placed in contact with the core 1 of the cable 100, surrounded by an electrically insulating second layer 3, in turn covered by a semiconducting third layer 4. The outer layer 5 is a sheath which protects the cable 100 and is formed by the cylindrical body according to the present invention.

A blend of the constituents indicated in Example 1 is prepared. In the extruder, the blend is transported with the aid of a screw from the feed zone to the die. The pressure increases progressively along the screw, thereby forcing the blend to pass through the die to impart a fixed shape to it at the exit therefrom. By fitting an appropriate die head, this technique allows the copper (for example) wires (not shown) of the core 1 of the cable 100 to be covered.

Of course, the preceding description has been given by way of purely illustrative example. Any means can be replaced by equivalent means without departing from the scope of the invention.

Thus polymers that are not hydrosilylizable can be added during the blending step.

Similarly, the process according to the invention can be used to manufacture a crosslinked material with a shape other than cylindrical.

There is claimed:

1. A process for manufacturing a cylindrical body, said process comprising:
a step of blending at least two unsaturated polymer chains each having at least one branch with a carbon-carbon double bond and a hydrosilylizing compound having at least two silicon-hydrogen bonds in the presence of at least one hydrosilylation catalyst, the blend obtained being uncrosslinked, and
a step of extruding said blend, the crosslinking of said blend by hydrosilylation being completed after said extrusion step.

2. The process claimed in claim 1 for manufacturing a cylindrical body, wherein said blending step has a duration of significantly less than five minutes.

3. The process claimed in claim 1 for manufacturing a cylindrical body, wherein said uncrosslinked blend contains significantly less than 1% of the total weight of said catalyst(s), and preferably from 100 ppm to 300 ppm thereof.

4. The process claimed in claim 1 for manufacturing a cylindrical body, wherein said catalyst(s) are chosen from molecules based on transition metals from column VIII of the Periodic Table of the Elements such as palladium, rhodium, platinum and associated complexes.

5. The process claimed in claim 1 for manufacturing a cylindrical body, wherein said blending step is carried out at temperatures from 60° C. to 180° C.

6. The process claimed in claim 1 for manufacturing a cylindrical body, wherein at least one of said carbon-carbon double bonds is of the pendent type.

7. The process claimed in claim 1 for manufacturing a cylindrical body, wherein each of said polymer chains belongs to a polymer chosen from thermoplastic polymers.

8. The process claimed in claim 1 for manufacturing a cylindrical body, wherein each of said polymer chains belongs to a polyvinyl chloride.

9. The process claimed in claim 1 for manufacturing a cylindrical body, wherein each of said polymer chains belongs to a polymer chosen from olefins, polyolefins and preferably from EPDMs and polyethylenes.

10. The process claimed in claim 1 for manufacturing a cylindrical body, wherein said hydrosilylizing compound is chosen from silanes, polysilanes and siloxanes.

11. The process claimed in claim 1 for manufacturing a cylindrical body, wherein said hydrosilylizing compound is a methylhydro-cyclosiloxane.

12. The process claimed in claim 1 for manufacturing a cylindrical body, wherein said hydrosilylizing compound includes at least two silicon-hydrogen bonds carried by the same silicon.

13. The process claimed in claim 1 for manufacturing a cylindrical body, wherein a fire retardant filler is added during said blending step.

14. A cable including a sheath and/or insulation obtained by a manufacture process as claimed in claim 1.
